(19) United States
(12) Patent Application Publication
(10) Pub. No.: US 2021/0121910 A1
(43) Pub. Date: Apr. 29, 2021

(54) INTEGRATED AT LEAST TWO COMPONENT SYSTEM AND METHOD

(71) Applicants: Karen L. Gayton, Gainesville, GA (US); Jacob Heath Gayton, Gainesville, HI (US)

(72) Inventors: Karen L. Gayton, Gainesville, GA (US); Jacob Heath Gayton, Gainesville, HI (US)

(21) Appl. No.: 16/890,923

(22) Filed: Jun. 2, 2020

Related U.S. Application Data
(63) Continuation-in-part of application No. 15/186,473, filed on Jun. 18, 2016, now Pat. No. 10,667,592.

(51) Int. Cl. B05C 17/005; B05C 11/10; B01F 13/00; B01F 11/00; B01F 15/02; A45D 19/00; A45D 40/24

(52) U.S. Cl. CPC B05C 17/00553; A45D 2200/058; B05C 17/00586; B05C 11/1026; B01F 13/0022; B01F 11/0065; B01F 15/0206; B01F 15/029; B01F 15/0292; B01F 13/0052; A45D 19/0066; A45D 40/24; B01F 2215/0031; B01F 2215/0039; B01F 2215/006; B05C 17/00583

(57) ABSTRACT

The present invention is an integrated at least two component system and method which combines at least two or more components and creates at least one new mixture. This system contains at least one first component in a first, optionally sealed, container and at least one second component in a second sealed container that is contained in or adjacent to the first container. Both components can be in a single container sealed off from each other. This system enables the mixing of these components to produce a new mixture, and then enables the application of this new mixture to be applied on at least one surface

### CROSS-REFERENCE TO RELATED APPLICATIONS

This application is a continuation in part of application Ser. No. 15/186,473, filed Jun. 18, 2016.

### INCORPORATION BY REFERENCE

This application hereby incorporates herein by reference in their entireties U.S. patent application Ser. No. 15/186,473, and any patent issuing therefrom, and U.S. Pat. Nos. 5,213,236, 7,793,667 and 7,631,645. Although other patents are incorporated within the remainder of the specification as well.

### FIELD OF THE INVENTION

The present invention can be used in many fields involving the mixing of two or more components. One example is the field of coloring hair, and other examples include glues, epoxy compounds, stain removers, etc.

### SUMMARY OF THE INVENTION

The present invention is an integrated at least two component system and method which combines at least two or more components and creates at least one new mixture. In certain embodiments, the invention also enables application of the new mixture onto at least one surface. The invention is useful for any type of mixable products, such as hair coloring, 2 part epoxy, 2 part stain removers, 2 part glues, 2 part removers, 3 or more part mixable products, etc.

When the invention is used in the field of coloring hair, it is especially useful in the field of portable, disposable devices for coloring hair re-growth, particularly hair roots, and/or adding highlights and streaks, and methods for coloring hair using such devices.

The invention is an integrated at least two Component system which creates at least One New Mixture and then enables the application of said at least one New Mixture onto at least one Surface.

This system contains at least one first Component in a first, optionally sealed, container and at least one second Component in a second sealed container that is contained in or adjacent to the first container. Both components can be in a single container sealed off from each other. This system enables the mixing of these Components to produce a New Mixture, and then enables the application of this New Mixture to be applied on at least one Surface, and this is accomplished via several embodiments described herein.

In a first embodiment, the invention is an integrated at least two component system for applying a substance to at least one surface comprising:

(A) an outer container made from a flexible material and having a closed bottom and sides and an open top, the outer container containing at least one first component;

(B) at least one breakable ampoule contained within the outer container; wherein the at least one breakable ampoule contains at least one second component, whereupon the rupturing and/or puncturing and/or breaking and/or crushing and/or squeezing of the at least one breakable ampoule, to release the at least one second component, allows mixing of the at least one first component with the at least one second component to form a new mixture;

the outer container further comprising at least one button for piercing and/or rupturing and/or puncturing and/or breaking and/or crushing and/or squeezing of the at least one breakable ampoule;

and

(C) a rotatable applicator valve assembly comprising:
a) an applicator subassembly for applying the new mixture comprising:

i) an applicator outer first end enabling the new mixture to pass from the interior of the rotatable applicator valve assembly through the applicator outer first end to the exterior ambient;

ii) an applicator inner second end containing a rotatable first valve cylindrical plate containing a rotatable first valve cylindrical plate hole;
b) a stationary second valve cylindrical plate attached to the open top while permitting rotation of the applicator subassembly,

the stationary second valve cylindrical plate containing a stationary second valve cylindrical plate hole,

the rotatable first valve cylindrical plate being capable of rotating when the applicator subassembly is rotated,

the rotatable first valve cylindrical plate hole capable of aligning at a first aligning angle with the stationary second valve cylindrical plate hole producing a valve open position and allowing the new mixture to pass from the interior of the outer container into the interior of the rotatable applicator valve assembly when the rotatable applicator valve assembly is rotated to an open position and/or when external pressure and/or manual force is applied to the outer container and/or when pressure increases sufficiently within the interior of the outer container,

and

when the rotatable first valve cylindrical plate hole is not aligned with the stationary second valve cylindrical plate hole the new mixture is blocked in at least one closed position and prevented from passing from the interior of the outer container into the interior of the rotatable applicator valve assembly.

In a second embodiment, the invention is a method for applying a new mixture to at least one surface comprising at least one of the following steps:

A)

1) pushing at least one button on an outer container to break at least one ampoule contained within the outer container, the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly

or

B)

1) pushing at least one button on an outer container to pierce and/or rupture and/or puncture and/or break at least one ampoule contained within the outer container, whereby pushing the at least one button causes a blade within the button to push out from within the button into the outer container to pierce and/or rupture and/or puncture and/or break the at least one ampoule contained within the outer container, the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly;

or

C)

1) pushing at least one button on an outer container to rupture and/or puncture and/or break and/or crush and/or squeeze at least one ampoule contained within the outer container, whereby pushing the at least one button causes an inner end of the button to push out into the outer container to rupture and/or puncture and/or break and/or crush and/or squeeze the at least one ampoule contained within the outer container,

the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly;

or

D)

1) pushing at least one set of buttons on an outer container to rupture and/or puncture and/or break and/or crush and/or squeeze at least one ampoule contained within the outer container, each set of buttons having at least two buttons on opposing sides of the outer container whereby the set of buttons can be pressed against each other to rupture and/or puncture and/or break and/or crush and/or squeeze at least one ampoule contained within the outer container, the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly;

or

E)

1) rotating a rotatable applicator valve assembly from at least one closed position to a rupture position at a second aligning angle to rupture a rupture membrane on a vessel contained within an outer container, the outer container containing a first component and the vessel containing a second component;

2) rotating the rotatable applicator valve assembly from the rupture position at a second aligning angle to a mixing position at a third aligning angle;

3) squeezing and/or massaging and/or shaking the outer container to mix the second component contained within the flexible vessel with the first component contained within the outer container to create the new mixture;

4) rotating the rotatable applicator valve assembly from the mixing position at a third aligning angle to a valve open position at a first aligning angle to allow the new mixture to flow out of the outer container and/or the rotatable applicator valve assembly into the applicator tip contained within the rotatable applicator valve assembly;

5) squeezing the outer container to force the new mixture out of the outer container into the applicator tip, and applying the new mixture to at least one surface and/or chosen hair area;

6) if there is any new mixture remaining in the outer container, rotating the rotatable applicator valve assembly from the valve open position at a first aligning angle to any closed position to prevent the new mixture from exiting and/or leaking out of the rotatable applicator valve assembly.

In a third embodiment, the invention is an integrated at least two component system for applying a substance to at least one surface comprising:

a container made from a flexible material and having a closed bottom and sides, an interior and an open top for applying a substance, the container having at least one first section adjacent the open top and at least one second section adjacent the closed bottom, the at least one first section containing at least one first component, the at least one second section containing at least one second component;

at least one, one-way valve, interposed between the at least one first section and the at least one second section, the valve having a valve head containing an opening through which the second component can enter the first section to mix with the first component when the container is squeezed to create a mixture.

### BRIEF DESCRIPTION OF THE DRAWINGS

FIG. 1 shows a cross-sectional representation of one embodiment of the invention;

FIG. 2A shows a cross-sectional representation of a valve in a closed position;

FIG. 2B shows a cross-sectional representation of the same valve of FIG. 2A in an open position;

FIG. 3 shows a cross-sectional representation of one embodiment of an Ampoule with a jacketed filter;

FIG. 4A shows a schematic representation of a bottom view of the rigid containment release vessel in the closed position;

FIG. 4B shows a schematic representation of a bottom view of the rigid containment release vessel in the mixing position;

FIG. 4C shows a schematic representation of a bottom view of the rigid containment release vessel in the open position;

FIG. 5A shows a top view of a button used in one embodiment of the present invention;

FIG. 5B shows a side view of a button and an ampoule in one embodiment of the present invention;

FIG. 5C shows a cross-sectional side view of a button in one embodiment of the present invention;

FIG. 5D shows a cross-sectional side view of the button in FIG. 5C in another position;

FIG. 5E shows a cross-sectional side view of a button in another embodiment of the present invention;

FIG. 6A shows a cross-sectional side view of a container in one embodiment of the present invention;

FIG. 6B shows a cross-sectional side view of the container of FIG. 6A at another stage of preparation;

FIG. 6C shows a cross-sectional side view of the container of FIG. 6A at yet another stage of preparation;

FIG. 7A shows a cross-sectional side view of a container in one embodiment of the present invention;

FIG. 7B shows a cross-sectional side view of the container of FIG. 7A at another stage of preparation; and

FIG. 7C shows a cross-sectional side view of the container of FIG. 7A at yet another stage of preparation.

### DETAILED DESCRIPTION OF THE INVENTION

The terms used herein shall have their ordinary and usual meanings as well as any meanings further defined herein and as set forth in the following Definitions section. The meaning set forth in the following Definitions section shall take precedence if there is any dispute between the ordinary and usual meaning and that set forth in the Definitions section.

### Definitions

Ampoule: a sealed capsule, vessel or section containing a liquid, cream, gel or other component to be mixed, usually of certain measured quantity ready for use.

And/or: As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

Applicator tip material: material suitable to soak up composition and transfer it to a surface.

Component: A component can be at least one of in whole or in part a solid, liquid, gas, suspension, colorant, hair colorant, dye, ink, fluorescing material, adhesive, cement, glue, plastic, sculpting material to build up a surface three-dimensionally, plaster, rubber and/or synthetic rubber, a cleaning solution, medication, medicine, mixture, element, compound, formula, a catalyst, hydrogen peroxide, ammonia, a binder, accelerant, coagulant, and/or other known or unknown catalyst.

At least one first component: can be at least one component.

At least one second component: can be at least one component.

New Mixture: A new mixture can be a coloring mixture, a hair coloring mixture, semi-permanent hair coloring mixture, permanent hair coloring mixture, at least one first component mixed with at least one second component.

Surface: At least one surface is hair and/or a portion thereof, any surface and/or a portion thereof upon which a mixture and/or new mixture and/or component and/or material can be applied.

Substance: A substance is at least one of at least one component, a mixture, a new mixture.

The following is a list of components identified in the figures.

### COMPONENTS

1 applicator (e.g., sponge)
2 filter (e.g., mesh sheet permits air flow, but no particles)
3 component 1 (e.g., liquid, paste, cream, gel)
4 squeezable valve/ampoule in a closed position
5 component 2 (e.g., liquid, paste, cream, gel)
6 valve/ampoule in open position (it lets the other component move from one section to the next with a force to the extent it is mixing them)
7 components being mixed
8 components mixed into new mixture and ready for application
17 jacketed filter
18 open top contains integral screw threads
19 end
20 outer container
21 rotatable applicator valve assembly
22 applicator tip
23 ampoule
24 second component
25 first component
26 rotatable first valve cylindrical plate
27 rotatable first valve cylindrical plate hole
28 stationary second valve cylindrical plate
29 stationary second valve cylindrical plate hole
30 filter
31 at least one closed position
32 valve open position
33 New Mixture
34 interior portion of the rotatable applicator valve assembly
40 rigid containment and release vessel
41 inner rotating cylinder
42 IRCslot1
43 IRCslot2
44 inner rotating cylinder interior compartment
45 shad. attachment
46 outer stationary cylinder
47 OSCslot1
48 OSCslot2
60 at least one closed position at a second aligning angle (top valve closed, cylinder valve closed)
61 mixing position at a third aligning angle (top valve closed, cylinder valve open)
62 valve open position at a ⁻first aligning angle (top valve open, cylinder valve open)

The following are not shown in the drawings, but are shown in U.S. Pat. Nos. 7,793,667 and 7,631,645, which are incorporated by reference herein in their entireties:

flexible vessel—not shown in drawings

rupture membrane—not shown in drawings

puncture lance—not shown in drawings

lead screw—not shown in drawings

rotation-arresting, spleen—not shown in drawings

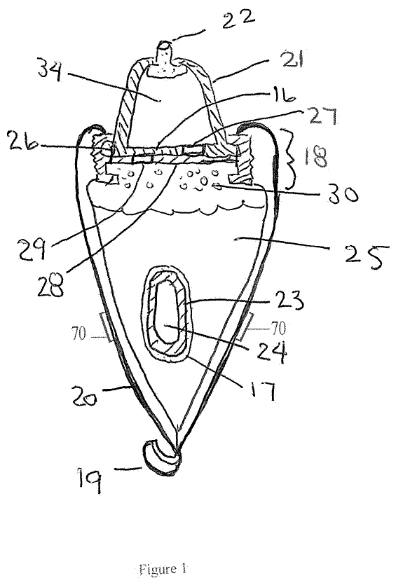

FIG. 1 shows a cross-sectional representation of one embodiment of the invention. Shown is the outer container 20, which can be a flexible container that can be pressed, manipulate, and/or compressed by squeezing manually. At the bottom of the outer container 20 is the end 19 and at the top is located the open top contains integral screw threads 18 where the rotatable applicator valve assembly 21 attaches. Within the outer container 20 is located the first component 25 and within the first Component 25 is the Ampoule 23 in which is contained second Component 24. When the outer container 20 is manually compressed it is possible to break and shatter the Ampoule 23, thus releasing the second Component 24 into the colorant 25. When squeezing by hand the outer container 20 the second Component 24 is mixed into the colorant 25 to produce a New Mixture 33 not shown but described as the result of this mixing process. The rotatable applicator valve assembly 21 screws into and is locked within the open top contains integral screw threads 18. The rotatable applicator valve assembly 21 is composed of a rotatable first valve cylindrical plate 26 containing a rotatable first valve cylindrical plate hole 27 and a stationary second valve cylindrical plate 28 containing a stationary second valve cylindrical plate hole 29. At the top end of the rotatable applicator valve assembly 21 is the applicator tip 22 from which the New Mixture 33 emanates and is selectively applied to desired locations to color hair. Also show is filter 30, which prevents particulate material from the breaking of Ampoule 23 20 from entering the rotatable applicator valve assembly 21.

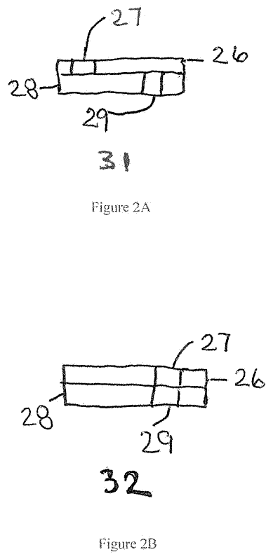

FIG. 2 shows a cross-sectional representation of a valve in at least one closed position 31 and the same valve in an valve open position 32. At least one closed position 31 shows the rotatable first valve cylindrical plate hole 27 located in the rotatable first valve cylindrical plate 26 misaligned with the stationary second valve cylindrical plate hole 29 located in the stationary second valve cylindrical plate 28, thus preventing New Mixture 33 from entering the interior portion of the rotatable applicator valve assembly 34 depicted in FIG. 1. This is a mirror image of the valve alignment position shown in FIG. 1, and shown for example of the valve theory operation only.

Valve open position 32 shows the rotatable first valve cylindrical plate hole 27 located in the rotatable first valve cylindrical plate 26 aligned with the stationary second valve cylindrical plate hole 29 located in the stationary second valve cylindrical plate 28, thus allowing New Mixture 33 to enter and fill the interior portion of the rotatable applicator valve assembly 34 and subsequently saturate and exit the applicator tip 22 for application to selective portions of hair for coloring with the ⁻New Mixture 33. There can also be detents (not shown) which can designate and/or define the various open and/or closed and/or other positions in other embodiments, and these &tents can be produced at the mating Surfaces of the rotatable first valve cylindrical plate 26 and said stationary second valve cylindrical plate 28.

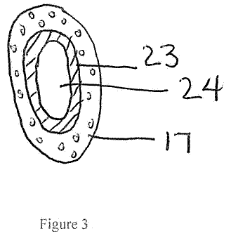

FIG. 3 shows a cross-sectional representation of one embodiment of a Ampoule with a jacketed filter. Shown is the Ampoule 23 filled with second Component 24 as could be depicted in FIG. 1. However, in this embodiment, the filter 30 of FIG. 1 is omitted and replaced with a jacketed filter 17 located around the Ampoule 23.

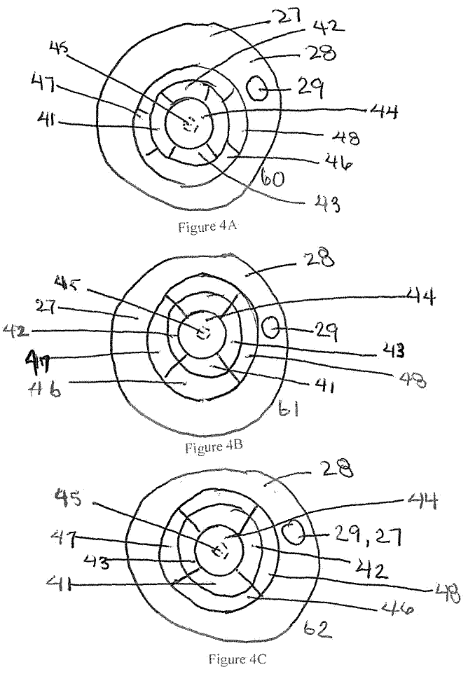

FIG. 4 shows a schematic representation of a bottom view of the rigid containment release vessel 40 in at least one closed position at a second aligning angle 60 or the closed position, the mixing position at a third aligning angle 61 or the mixing position, and the valve open position at a first aligning angle 62 or the open position.

A rigid containment and release vessel 40 is constructed from an inner rotating cylinder 41 and an outer stationary cylinder 46. The outer stationary cylinder 46 is connected to stationary second valve cylindrical plate 28 and remains in a fixed position relative to the outer container 20 shown in FIG. 1 but the outer container 20 is not shown in FIG. 4 for clarity. The inner rotating cylinder 41 is connected via shaft attachment 45 to rotatable first valve cylindrical plate 26. Rotatable first valve cylindrical plate 26 is located directly behind stationary second valve cylindrical plate 28. Rotatable first valve cylindrical plate 26 has rotatable first valve cylindrical plate hole 27 which can either align. or misalign with stationary second valve cylindrical plate hole 29 located on the stationary second valve cy'lindrica.1 plate 28.

Inner rotating cylinder 41 has within the cylinder wall a pair of slots IRCslot1 42 and IRCslot2 43, and these slots can either align or misalign with slots OSCslot1 47 and OSCslot2 48 located within the cylinder wall of outer stationary cylinder 46. When the slots are aligned, the second Component 24 can pass through the slots and mix with first Component 25 located within outer container 20. in this embodiment there are two simultaneous valve functions occurring: the passage or blockage of material between the inner rotating cylinder interior compartment 44 and the outer container 20 (depending on the orientation of slots IRCslot1 42 and IRCslot2 43 with slots OSCslot1 47 and OSCslot2 48) and the passage or blockage of material between the inner compartment 20 and the rotatable applicator valve assembly 21 (depending upon the relative positions of the rotatable first valve cylindrical plate hole 27 and the stationary second valve cylindrical plate hole 29. Both valves are operated simultaneously via the movement of rotatable first valve cylindrical plate 26 relative to stationary second valve cylindrical plate 28. The three valve positions are elucidated as follows:

At least one closed position at a second aligning angle 60, which could be considered the shipping position, shows slots IRCslot1 42 and IRCslot2 43 located on inner rotating cylinder 41 in a misaligned position relative to slots OSCslot1 47 and OSCslot2 48 located on outer stationary cylinder 46, thus keeping second Component 24 trapped within the inner rotating cylinder interior compartment 44. Simultaneously, rotatable first valve cylindrical plate hole 27 on rotatable first valve cylindrical plate 26 is misaligned with stationary second valve cylindrical plate hole 29 located on stationary second valve cylindrical plate 28, thus preventing any material or New Mixture 33 from entering the rotatable applicator valve assembly 21.

Next is shown mixing position at a third aligning angle 61, where IRCslot1 42 is aligned with OSCslot1 47 and IRCslot2 43 is aligned with OSCslot2 48, and thus second Component 24 can now pass freely between the slots and can mix with first Component 25 to create New Mixture 33, which can occur via the manual action of or force applied and/or squeezing and/or shaking of the outer container 20. During this mixing function there is misalignment between rotatable first valve cylindrical plate hole 27 and stationary second valve cylindrical plate hole 29, and thus no New Mixture 33 can pass through these two holes and enter the rotatable applicator valve assembly 21.

Once mixing is complete, the rotatable applicator valve assembly 21 can be rotated to valve open position at a first aligning angle 62. in this position, because the rotatable first valve cylindrical plate 26 has rotated 180 degrees, IRCslot1 42 is aligned with OSCslot2 48 and IRCslot2 43 is aligned with OSCslot1 47, so the inner rotating cylinder interior compartment 44 is still open and residual concentration of the second Component 24 can continue to be mixed with the first Component 25 and New Mixture 33 can fill outer container 20. And in this position rotatable first valve cylindrical plate hole 27 is aligned with stationary second valve cylindrical plate hole 29 and New Mixture can pass from the outer container 20 into the rotatable applicator valve assembly 21, the applicator tip 22, and New Mixture 33 can be applied to a Surface which can be hair or any other Surface.

One example of the invention is an integrated at least two component system for applying a substance to at least one surface comprising:

(A) an outer container made from a flexible material (any material sufficiently flexible to mix the components, such as, but not limited to, plastic, rubber, metal, aluminum, etc.) and having a closed bottom and sides and an open top, the outer container containing at least one first component;

(B) at least one breakable ampoule contained within the outer container; wherein the at least one breakable ampoule contains at least one second component, whereupon the rupturing and/or puncturing and/or breaking and/or crushing and/or squeezing of the at least one breakable ampoule, to release the at least one second component, allows mixing of the at least one first component with the at least one second component to form a new mixture;

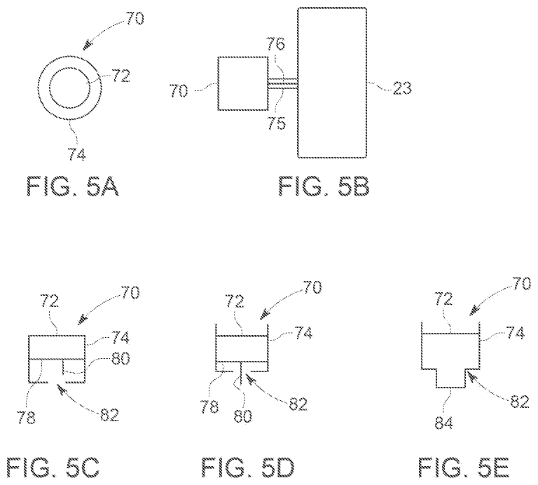

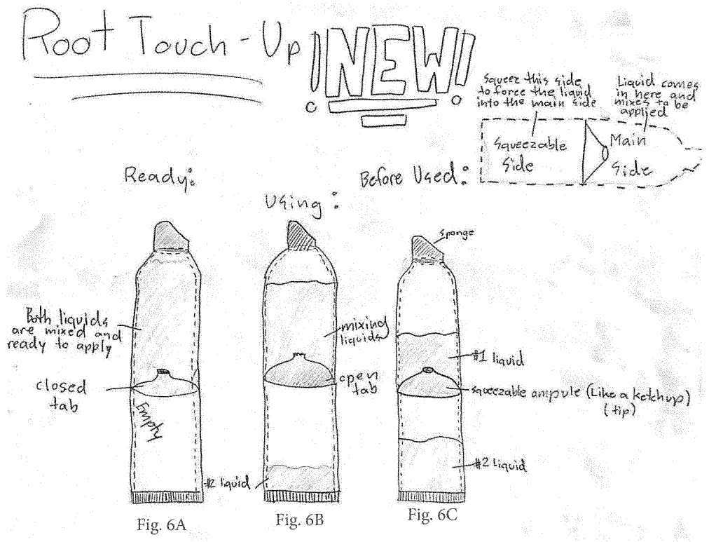

the outer container further comprising at least one button 70, See FIG. 1, (there can be another button 70 for opening other ampoules or to provide a force to press each button against each other to make the buttons work more easily, the button has a central section 72 which is pressed to activate the button 70 and an outer column or sheath 74 which contains the active central mechanism section 72 and extends into the inside of the outer container to house the inner portion of the button 70] which can be attached to the at least one ampoule 23 (as shown, for example, in FIG. 5B, by attaching device 75, which, in this example, has a tube or channel for piercing device 76 to open ampoule 23), or which un-sheaths to reveal a piercing end of blade 80 (as shown in FIGS. 5C and 5D, the blade 80 is attached to the inner end 78 of the button 70, i.e., the end that is facing inside and can enter inside the outer container 20, and the ampoule can be protected from the blade 80 up until the time the central portion 72 of the button 70 is depressed, as shown in FIG. 5D, by limiting the opening in sheath or column 74 to the partial opening 82, as shown, the blade 80 is attached to the bottom portion 78 of the central portion 72 of button 70), un-sheaths blunt end of button 84 (as shown in FIG. 5E, where again the opening in sheath or column 74 is limited to a partial opening 82, to better protect the ampoule from opening until the button 70 is depressed, but the opening 82 does not have to be partial and can be the full circumference of column or sheath 74, the blunt end of button 84 can be used to break open, rupture, etc. ampoule 23), or include an additional button on the opposite side of outer container 20, as shown in FIG. 1 (one or more buttons can be located anywhere on the outer container, it can be helpful to have two such buttons on opposing sides of the container to balance the force against each one, so they each have something to press upon), for piercing and/or rupturing and/or puncturing and/or breaking and/or crushing and/or squeezing of the at least one breakable ampoule;

and

(D) a rotatable applicator valve assembly [which can be made of any suitable materials, such as rubber, plastic, metal, ceramics, etc.] comprising:
a) an applicator subassembly for applying the new mixture comprising:

iii) an applicator outer first end enabling the new mixture to pass from the interior of the rotatable applicator valve assembly through the applicator outer first end to the exterior ambient;

iv) an applicator inner second end containing a rotatable first valve cylindrical plate containing a rotatable first valve cylindrical plate hole;
b) a stationary second valve cylindrical plate attached to the open top while permitting rotation of the applicator subassembly,

the stationary second valve cylindrical plate containing a stationary second valve cylindrical plate hole,

the rotatable first valve cylindrical plate being capable of rotating when the applicator subassembly is rotated,

the rotatable first valve cylindrical plate hole capable of aligning at a first aligning angle with the stationary second valve cylindrical plate hole producing a valve open position and allowing the new mixture to pass from the interior of the outer container into the interior of the rotatable applicator valve assembly when the rotatable applicator valve assembly is rotated to an open position and/or when external pressure and/or manual force is applied to the outer container and/or when pressure increases sufficiently within the interior of the outer container,

and

when the rotatable first valve cylindrical plate hole is not aligned with the stationary second valve cylindrical plate hole the new mixture is blocked in at least one closed position and prevented from passing from the interior of the outer container into the interior of the rotatable applicator valve assembly.

In another example of the above invention, the button has an inner end 78 on one side of the button, located within the outer container, and an outer end 72 on the other side, the inner end comprising at least one of the following:

A. a sharp end of a blade 80 within the button 70 for piercing and/or rupturing and/or puncturing and/or breaking the at least one breakable ampoule;

B. a blunt end 84 for rupturing and/or puncturing and/or breaking and/or crushing and/or squeezing the at least one breakable ampoule;

C. an attaching device 75, attaching the inner end of the button to the at least one breakable ampoule (of course if there are more ampoules, the button can be attached to all of them or there can be buttons for each ampoule to attach to, not shown), whereby the inner end of the button can pierce and/or rupture and/or puncture and/or break and/or crush and/or squeeze the at least one breakable ampoule (if it's attached, as shown in FIG. 5B, it's easier to make certain that the button will contact the ampoule to pierce and/or rupture and/or puncture and/or break and/or crush and/or squeeze the ampoule). In this example, the attaching device can be an attaching tube in which a needle can travel from the inner end of the button to pierce and/or rupture and/or puncture and/or break the ampoule.

In another example of the above invention, the outer first end has an applicator tip which is at least one of a brush, foam, sponge, a comb, hose, a nozzle, a membrane permitting material transfer and/or diffusion, an applicator tip material [suitable to soak up composition and transfer it to a surface], a tube or series of tubes.

In another example of the above invention, there is also added a filter contained within the outer container or the rotatable applicator and valve assembly, or a filter surrounding and/or encasing the at least one breakable ampoule, the filter capable of preventing particulate material from passing from the outer container into the rotatable applicator valve assembly, and wherein the filter is at least one of in whole or in part foam, rubber, plastic, metal, screening, mesh, ceramic, cotton, and/or fibrous material.

In another example of the above invention, there is also added at least one of the following:

A. at least one additional hair care product contained in the outer container, in at least one breakable ampoule and/or in at least one additional breakable ampoule;

B. at least one mixing ball and/or solid object within the interior of the outer container;

C. at least one additional vessel comprising:

(C1) a flexible vessel—with a rupture membrane affixed to one end,

the flexible vessel contained within the outer container and affixed to the stationary second valve cylindrical plate,

the flexible vessel containing at least one second component, whereupon the rupturing of the rupture membrane allows mixing of the at least one second component with the at least one first component to form the new mixture,

the rupture membrane being ruptured via the axial movement of a puncture lance caused to axially translate as a result of the rotation of the rotatable first valve cylindrical plate relative to the stationary second valve cylindrical plate using a lead screw and a rotation-arresting spline, (a rupture membrane, puncture lance, lead screw and rotation-arresting spline are shown in one or both of U.S. Pat. Nos. 7,793,667 and 7,631,645, which are incorporated herein by reference in their entireties),

the rupturing of the flexible vessel occurring at a rupture position at a second aligning angle of the rotatable applicator valve assembly,

the second aligning angle being in at least one valve closed position to prevent material from entering the rotatable applicator valve assembly, and a mixing position at a third aligning angle between the rotatable first valve cylindrical plate relative to the stationary second valve cylindrical plate of the rotatable applicator valve assembly, and the third aligning angle being in at least one valve closed position to prevent material from entering the rotatable applicator valve assembly and retraction of puncture lance to allow free passage of the at least one second component from the flexible vessel into the interior of the outer container,

or

(C2) a rigid containment and release vessel—comprising an inner rotating cylinder with an inner rotating cylinder interior compartment and a shaft attachment to the rotatable first valve cylindrical plate and an outer stationary cylinder affixed to the stationary second valve cylindrical plate,

the outer stationary cylinder containing at least two outer release slots;

the inner rotating cylinder containing at least two inner release slots;

the rigid containment and release vessel contained below the stationary second valve cylindrical plate and within the the outer container,

the rigid containment and release vessel containing within the inner rotating cylinder interior compartment at least one second component,

the rigid containment and release vessel being capable of being set to at least one closed position at a second aligning angle wherein the at least one second component contained within the inner rotating cylinder interior compartment cannot escape the inner rotating cylinder interior compartment and the at least one first component and/or the new mixture contained within the outer container cannot enter the rotatable applicator valve assembly, and

the rigid containment and release vessel being capable of being set to a mixing position at a third aligning angle wherein the at least two outer release slots and the at least two inner release slots are aligned and at least one second component can pass out of the inner rotating cylinder interior compartment and mix with the at least one first component contained within the outer container when external pressure and/or massaging and/or squeezing and/or shaking and/or manual force is applied to the outer container to create the new mixture and the new mixture is contained within the outer container and cannot enter the rotatable applicator valve assembly, and

the rigid containment and release vessel being capable of being set to a valve open position at a first aligning angle wherein the at least two outer release slots and the at least two inner release slots are aligned and at least one second component can pass out of the inner rotating cylinder interior compartment and mix with at least one first component contained within the outer container to create and/or continue to create the new mixture and the new mixture contained within the outer container and can enter the rotatable applicator valve assembly when external pressure and/or massaging and/or squeezing and/or manual force is applied to the outer container and/or when pressure increases sufficiently within the interior of the outer container.

In another example of the above invention, the external pressure and/or manual force and/or the mixing is generated by the act of squeezing and/or shaking the outer container with at least one human hand.

In another example of the above invention, the open top contains integral screw threads capable of mating with complimentary screw threads on the rotatable applicator valve assembly to enable the rotatable applicator valve to attach to the open top.

In another example of the above invention, the valve open position and/or the at least one closed position are designated and/or defined by at least one mechanical detent produced at the mating surfaces of the rotatable first valve cylindrical plate and the stationary second valve cylindrical plate.

In another example of the above invention, the ampoule further comprises of at least one of a breakable sealed glass container, a housing, at least one breakaway membrane, at least one puncturing and/or piercing edge and/or tooth to puncture the at least one breakaway membrane when the external pressure and/or manual force is applied to at least one location to the outer container.

Another example of the invention is a method for applying a new mixture to at least one surface comprising at least one of the following steps:

A)

1) pushing at least one button on an outer container to open at least one ampoule contained within the outer container, the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly

or

B)

1) pushing at least one button on an outer container to pierce and/or rupture and/or puncture and/or break at least one ampoule contained within the outer container, whereby pushing the at least one button causes a blade within the button to push out from within the button into the outer container to pierce and/or rupture and/or puncture and/or break the at least one ampoule contained within the outer container, [the blade can be retracted back into the interior end of the button after the pushing stops]

the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly;

or

C)

1) pushing at least one button on an outer container to rupture and/or puncture and/or break and/or crush and/or squeeze at least one ampoule contained within the outer container, whereby pushing the at least one button causes an inner end of the button to push out into the outer container to rupture and/or puncture and/or break and/or crush and/or squeeze the at least one ampoule contained within the outer container, [the inner end of the button can be retracted back into the button sheath and/or wall of the outer container after the pushing stops]

the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly;

or

D)

1) pushing at least one set of buttons on an outer container to rupture and/or puncture and/or break and/or crush and/or squeeze at least one ampoule contained within the outer container, each set of buttons having at least two buttons on opposing sides of the outer container whereby the set of buttons can be pressed against each other to rupture and/or puncture and/or break and/or crush and/or squeeze at least one ampoule contained within the outer container,

the outer container also containing at least one first component and the at least one ampoule containing at least one second component;

2) squeezing and massaging the outer container to mix the at least one second component contained within the ampoule with the at least one first component contained within the outer container to create the new mixture;

3) rotating a rotatable applicator valve assembly from at least one closed position to an open position to allow the new mixture to flow out of the rotatable applicator valve assembly into the applicator tip contained within the rotatable applicator valve assembly;

4) squeezing the outer container to force the new mixture out of the outer container into the applicator tip, and applying the new mixture to chosen surface or hair area;

5) if there is any new mixture remaining in the outer container, rotating the rotatable applicator valve assembly from the open position to the at least one closed position to prevent the new mixture from exiting and/or leaking out of the rotatable applicator valve assembly;

or

E)

1) rotating a rotatable applicator valve assembly from at least one closed position to a rupture position at a second aligning angle to rupture a rupture membrane (as disclosed in the inventor's U.S. Pat. Nos. 7,793,667 and/or 7,631,645 which are incorporated herein by reference in their entireties) on a vessel contained within an outer container, the outer container containing a first component and the vessel containing a second component;

2) rotating the rotatable applicator valve assembly from the rupture position at a second aligning angle to a mixing position at a third aligning angle;

3) squeezing and/or massaging and/or shaking the outer container to mix the second component contained within the flexible vessel with the first component contained within the outer container to create the new mixture;

4) rotating the rotatable applicator valve assembly from the mixing position at a third aligning angle to a valve open position at a first aligning angle to allow the new mixture to flow out of the outer container and/or the rotatable applicator valve assembly into the applicator tip contained within the rotatable applicator valve assembly;

5) squeezing the outer container to force the new mixture out of the outer container into the applicator tip, and applying the new mixture to at least one surface and/or chosen hair area;

6) if there is any new mixture remaining in the outer container, rotating the rotatable applicator valve assembly from the valve open position at a first aligning angle to any closed position to prevent the new mixture from exiting and/or leaking out of the rotatable applicator valve assembly.

Yet another example of the invention is an integrated at least two component system for [combining at least two components] applying a substance to at least one surface comprising:

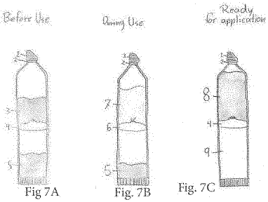

a container made from a flexible material (any material sufficiently flexible to mix the components, including, but not limited to, plastic, rubber, metal, aluminum, it can be the material used for a present day or old fashioned tube of toothpaste, etc.) and having a closed bottom and sides, an interior and an open top for applying a substance, the container having at least one first section adjacent the open top (such as the section containing first component 3 in FIG. 7A) and at least one second section adjacent the closed bottom (such as the section containing second component 5 in FIG. 7A), the at least one first section containing at least one first component, the at least one second section containing at least one second component (alternatively, the components can be in tubes within the container, which act like separate ampoules with the valve closure as claimed herein), FIG. 7A also shows optional sponge 1 for application and filter 2, the bottom of the container shown can be removed so that tubes of components can be inserted, instead of the components directly filling the container;

at least one, one-way valve 4 (shown closed in FIG. 7A, but valve 6 is open in FIG. 7B, then closed again if FIG. 7C), interposed between the at least one first section and the at least one second section (if one of the components is in a separate tube, then the one way valve can be used to seal the tube and operate to let the contents out of the tube when the user is ready, then the contents (component) can be forced by the opening of the valve (by squeezing the tube and/or outer container) into the other section of the container or into another tube containing another component), the valve having a valve head containing an opening through which the second component can enter the first section to mix with the first component when the container is squeezed to create a mixture, this is shown if FIG. 7B where second component 5 is being mixed 7 and the FIG. 7C shows the resulting new mixture 8 which is ready to be applied (the valve also has a valve body, the valve body having the valve head in the center thereof and having its ends attached to the interior of the container, but prior to being squeezed, the valve operating to keep the first and second components separate). One of the benefits of using this new valve arrangement is that it makes it easier to mix components of different viscosities and textures. For example, liquids, creams, gels and other compositions of the same or different viscosities and textures can easily be mixed in any combination because of using this type of valve. This valve can be seen, for example in U.S. Pat. Nos. 5,213,236, 5,339,995, 5,439,143, 5,839,614, 6,279,783, 6,427,874, 7,077,296 all of which are incorporated herein by reference in their entireties. As a result, it makes it especially useful for hair color preparations which usually include several components with different viscosities and textures. It also makes it easier to combine two or more cream compositions, or two or more gel compositions, or two or more liquid compositions, etc.

In another example of the above invention, also added is a rotatable applicator valve assembly comprising:

a) an applicator subassembly for applying the mixture comprising:
i) an applicator nozzle outer first end containing an applicator tip enabling the new mixture to pass from the interior of the rotatable applicator valve assembly through the applicator tip to the exterior ambient;
ii) an applicator nozzle inner second end containing a rotatable first valve cylindrical plate containing a rotatable first valve cylindrical plate hole;

b) a stationary second valve cylindrical plate attached to the open top while permitting rotation of the applicator subassembly,

the stationary second valve cylindrical plate containing a second valve cylindrical plate hole,

the rotatable first valve cylindrical plate being capable of rotating when the applicator subassembly is rotated,

the rotatable first valve cylindrical plate hole capable of aligning at a first aligning angle with the stationary second valve cylindrical plate hole producing a valve open position to allow the mixture to pass from the interior of the container into the interior of the rotatable applicator valve assembly when the rotatable applicator valve assembly is rotated to an open position and/or when external pressure and/or manual force is applied to the container and/or when pressure increases sufficiently within the interior of the container,

and

when the rotatable first valve cylindrical plate hole is not aligned with the stationary second valve cylindrical plate hole the new mixture is blocked and prevented from passing from the interior of the outer container into the interior of the rotatable applicator valve assembly.

In another example of the above invention, also added is a filter contained within the outer container or the rotatable applicator and valve assembly, or a filter surrounding and/or encasing the at least one vessel, the filter capable of preventing particulate material from passing from the outer container into the rotatable applicator valve assembly, and wherein the filter is at least one of in whole or in part foam, rubber, plastic, metal, screening, mesh, cotton, ceramic, fibrous material.

In another example of the above invention, the applicator tip is at least one of a brush, foam, sponge, a comb, a nozzle, a membrane permitting material transfer and/or diffusion, a tube or and/or series of tubes.

In another example of the above invention, also added is at least one of the following:

A. a mixing ball and/or solid object with the interior or of the outer container; and/or

B. at least one additional hair care product contained in the outer container and/or in at least one portion of the invention of claim 11.

In another example of the above invention, the external pressure and/or manual force and/or the mixing is generated by the act of squeezing and/or shaking the outer container with at least one human hand.

In another example of the above invention, the open top contains integral screw threads capable of mating with complimentary screw threads on the rotatable applicator valve to enable the rotatable applicator valve to attach to the open top.

In another example of the above invention, the valve open position and/or the rupture position at a second aligning angle and/or the mixing position at a third aligning angle are designated and/or defined by at least one mechanical detent produced at the mating surfaces of the rotatable first valve cylindrical plate and the stationary second valve cylindrical plate.

In another example of the above invention, also added is a method of squeezing the second section to open the valve and mix the first and second components to create a new mixture.

In another example of the method of squeezing immediately above, also added are the steps of rotating a rotatable applicator valve assembly from at least one closed position to an open position to allow the new mixture to flow out of the rotatable applicator valve assembly into an applicator tip contained within the rotatable applicator valve assembly;

squeezing the container to force the new mixture out of the container into the applicator tip, and applying the new mixture to chosen surface or hair area;

if there is any new mixture remaining in the container, rotating the rotatable applicator valve assembly from the open position to the at least one closed position to prevent the new mixture from exiting and/or leaking out of the rotatable applicator valve assembly.

In at least one embodiment an integrated at least two Component system for applying a substance to at least one Surface is comprised of: (A) an outer container made from a flexible material and having a closed bottom and sides and an open top, and the outer container contains at least one first Component; (B) at least one breakable ampoule can be contained within the outer container, and the at least one breakable Ampoule can contain at least one second Component; and whereupon the rupturing, breaking, crushing; and/or squeezing of at least one breakable Ampoule can allow the mixing of at least one first Component with at least one second Component to form a New Mixture; (C) a rotatable applicator valve assembly comprising: an applicator subassembly for applying, the New Mixture comprising: i) an applicator nozzle outer first end containing an applicator tip enabling the New Mixture to pass from the interior of the rotatable applicator valve assembly through the applicator tip to the exterior ambient; ii) an applicator nozzle inner second end containing a rotatable first valve cylindrical plate containing a rotatable first valve cylindrical plate hole, b) a stationary second valve cylindrical plate attached to the open top while permitting rotation of the applicator subassembly, and the stationary second valve cylindrical plate contains a stationary second valve cylindrical plate hole, and the rotatable first valve cylindrical plate is capable of rotating when the applicator subassembly is rotated, and the rotatable first valve cylindrical plate hole is capable of aligning at a first aligning angle with the stationary second valve cylindrical plate hole producing a valve open position and allowing the New Mixture to pass from the interior of the outer container into the interior of the rotatable applicator valve assembly when external pressure and/or manual force is applied to the outer container and/or when pressure increases sufficiently within the interior of the outer container, and when the rotatable first valve cylindrical plate hole is not aligned with the stationary second valve cylindrical plate hole the New Mixture is blocked in at least one closed position and prevented from passing from the interior of the outer container into the interior of the rotatable applicator valve assembly; (D) a filter contained within the outer container or the rotatable applicator and valve assembly, and the filter is capable of preventing particulate material from passing from the outer container into the rotatable applicator valve assembly.

The filter can be at least one of in whole or in part made from foam, rubber, plastic, metal, screening, mesh, ceramic, cotton, fibrous material.

The applicator tip can be at least one of a brush, foam, sponge, a comb, hose, a nozzle, a membrane permitting material transfer and/or diffusion, a material suitable to soak up composition and transfer it to a surface, a tube or series of tubes.

The invention can also have at least one mixing ball and/or at least one other object or solid object within the interior of the outer container.

The invention can include at least one additional product and/or hair care product contained in the outer container and/or in at least one ampoule,

Applied external pressure and/or manual force and/or mixing can be generated by the act of squeezing, grasping, shaking, and/or other applied pressure, force, mixing the outer container using at least one hand, finger, or other body part alone or in connection with use of at least one tool or other physical object.

The opening at top of the at least one outer container may contain integral screw threads capable of mating with complimentary screw threads on attachable devices including but not limited to an attachable and removable rotatable applicator valve assembly to enable the rotatable applicator valve to attach to the open top.

The valve in at least one open position and/or at least one closed position can be designated and/or defined by at least one mechanical detent produced at the mating Surfaces of the rotatable first valve cylindrical plate and the stationary second valve cylindrical plate.

The Ampoule may further comprise of at least one of a breakable sealed glass container, a housing, at least one breakaway membrane, at least one puncturing and/or piercing edge and/or tooth to puncture at least one breakaway membrane when external pressure and/or manual force is applied to at least one location to the outer container.

One method for applying a New Mixture to at least one Surface is comprised of the following steps: A) squeezing the outer container to break an Ampoule contained within the outer container; B) squeezing and massaging the outer container to mix the second Component contained within the Ampoule with the first Component contained within the outer container to create the New Mixture; C) rotating a rotatable applicator valve assembly from at least one closed position to an open position to allow the New Mixture to flow out of the rotatable applicator valve assembly into the applicator tip contained within the rotatable applicator valve assembly. D) squeezing the outer container to force the ⁻New Mixture out of the outer container into the applicator tip, and applying the New Mixture to a chosen Surface or hair area; E) if there is any New Mixture remaining in the outer container, the rotatable applicator valve assembly can. be rotated from the open position to at least one closed position to prevent any New Mixture from exiting and/or leaking out of the rotatable applicator valve assembly.

In at least one second embodiment the filter(s) are secured around the Ampoule(s). The invention can be an integrated at least two Component system for applying a substance to at least one Surface comprising: (A) an outer container made from a flexible material and having a closed bottom and sides and an open top, and the outer container can contain at least one first Component; (B) at least one breakable Ampoule contained within the outer container, wherein at least one breakable Ampoule contains at least one second Component, whereupon the rupturing and/or breaking and/or crushing and/or squeezing of at least one breakable ampoule allows mixing of at least one first Component with at least one second Component to form at least one New Mixture; (C) a rotatable applicator valve assembly comprising: a) an applicator subassembly for applying the New Mixture comprising: i) an applicator nozzle outer first end containing an applicator tip enabling the New Mixture to pass from the interior of the rotatable applicator valve assembly through the applicator tip to the exterior ambient; ii) an applicator nozzle inner second end containing a rotatable first valve cylindrical plate containing a rotatable first valve cylindrical plate hole; b) a stationary second valve cylindrical plate attached to the open top while permitting rotation of the applicator subassembly, and the stationary second valve cylindrical plate contains a stationary second valve cylindrical plate hole, and the rotatable first valve cylindrical plate being capable of rotating when the applicator subassembly is rotated, and the rotatable first valve cylindrical plate hole is capable of aligning at a first angle with the stationary second valve cylindrical plate hole to produce a valve open position and thus allowing the New Mixture to pass from the interior of the outer container into the interior of the rotatable applicator valve assembly when external pressure and/or manual force is applied to the outer container and/or when pressure increases sufficiently within the interior of the outer container, and when the rotatable first valve cylindrical plate hole is not aligned with the stationary second valve cylindrical plate hole the New Mixture is blocked in at least one closed position and prevented from passing from the interior of the outer container into the interior of the rotatable applicator valve assembly; (D) a filter surrounding and/or encasing the at least one breakable Ampoule, and the filter is capable of preventing particulate material from passing from the outer container into the rotatable applicator valve assembly.

The filter can be at least one of in whole or in part foam, rubber, plastic, metal, screening, mesh, cotton, ceramic, and/or fibrous material.

The applicator tip can be at least one of a brush, foam, sponge, a comb, a nozzle, a membrane permitting material transfer and/or diffusion, a tube or and/or series of tubes.

At least one mixing ball and/or solid object can be contained within the interior of the outer container.

The invention can also have at least one additional hair care product contained in the outer container and/or in at least one breakable Ampoule.

The external pressure and/or manual force and/or mixing can be generated by the act of squeezing and/or shaking the outer container with at least one human hand, finger or other area, and/or tool.

The open top can contain integral screw threads capable of mating with complimentary screw threads on the rotatable applicator valve to enable the rotatable applicator valve (or other device) to attach to the open top.

The valve open position and/or at least one dosed position can be designated and/or defined by at least one mechanical detent produced at the mating Surfaces of or between the rotatable first valve cylindrical plate and the stationary second valve cylindrical plate.

The Ampoule can further comprise of at least one of a breakable sealed glass container, a housing, at least one breakaway membrane, at least one puncturing and/or piercing edge and/or tooth to puncture said at least one breakaway membrane when said external pressure and/or manual force is applied to at least one location to the outer container.

A method for the second embodiment described above for applying a. New Mixture to at least one Surface can comprise the following steps: A) squeezing the outer container to break an Ampoule contained within the outer container; B) squeezing and massaging the outer container to mix the second Component contained within the Ampoule with the first Component contained within the outer container to create the New Mixture; C) rotating a. rotatable applicator valve assembly from a at least one closed position to an open position to allow the New Mixture to flow out of the rotatable applicator valve assembly into the applicator tip contained within the rotatable applicator valve assembly. D) squeezing the outer container to force the New Mixture out of the outer container into the applicator tip, and applying the New Mixture to at least one Surface and/or chosen hair area; E) if there is any New Mixture remaining in the outer container, rotating the rotatable applicator valve assembly from the open position to at least one closed. position to prevent any New Mixture from exiting and/or leaking out of the rotatable applicator valve assembly.

A third embodiment of the invention can have a puncture flexible vessel (or Ampoule) and lance system. An integrated at least two Component system for applying a substance to at least one Surface can comprise: (A) an outer container made from a flexible material and having a closed bottom and sides and an open top, and the outer container can contain at least one first Component; (B) a rotatable applicator valve assembly comprising: a) an applicator subassembly for applying a New Mixture comprising: i) an applicator nozzle outer first end containing an applicator tip enabling the New Mixture to pass from the interior of the rotatable applicator valve assembly through the applicator tip to the exterior ambient; an applicator nozzle inner second end containing a rotatable first valve cylindrical plate containing a rotatable first valve cylindrical plate hole; b) a stationary second valve cylindrical plate attached to the open top while permitting rotation of the applicator subassembly, and the stationary second valve cylindrical plate can contain a second valve cylindrical plate hole, the rotatable first valve cylindrical plate being capable of rotating when the applicator subassembly is rotated, and the rotatable first valve cylindrical plate hole is capable of aligning at a first aligning angle with the stationary second valve cylindrical plate hole producing a valve open position to allow the New Mixture to pass from the interior of the outer container into the interior of the rotatable applicator valve assembly when external pressure and/or manual force is applied to the outer container and/or when pressure increases sufficiently within the inter or of the outer container, and when the rotatable first valve cylindrical plate hole is not aligned with the stationary second valve cylindrical plate hole the ⁻New Mixture is blocked and prevented from passing from the interior of the outer container into the interior of the rotatable applicator valve assembly;

In this embodiment there are two possible second Component dispensing systems, the first second Component dispensing system being (CI) a flexible vessel with a rupture membrane affixed to one end, and the flexible vessel is contained within the outer container and affixed to the stationary second valve cylindrical plate, and the flexible vessel contains at least one second Component, whereupon the rupturing of the rupture membrane allows mixing of at least one second Component with at least one first Component to form the New Mixture, and the rupture membrane can be ruptured via the axial movement of a puncture lance caused to axially translate as a result of the rotation of the rotatable first valve cylindrical plate relative to the stationary second valve cylindrical plate using a lead screw and a rotation-arresting spline, and the rupturing occurring at a rupture position at a second aligning angle, and the second aligning angle being in at least one valve closed position to prevent material from entering the rotatable applicator valve assembly, and a mixing position at a third aligning angle between the rotatable first valve cylindrical plate relative to the stationary second valve cylindrical plate and the third aligning angle being in at least one valve closed position to prevent material from entering the rotatable applicator valve assembly and retraction of the puncture lance to allow free passage of at least one second Component from the flexible vessel into the interior of the outer container.

The next, or a second, second Component dispensing system being (C2) a rigid containment and release vessel comprising an inner rotating cylinder with an inner rotating cylinder interior compartment and a shaft attachment to the rotatable first valve cylindrical plate and an outer stationary cylinder affixed to the stationary second valve cylindrical plate, and the outer stationary cylinder can contain at least two outer release slots; the inner rotating cylinder can contain at least two inner release slots; the rigid containment and release vessel can be contained below the stationary second valve cylindrical plate and within the outer container; and the rigid containment and release vessel can contain. within the inner rotating cylinder interior compartment at least one second Component, the rigid containment and release vessel being capable of being set to at least one closed position at a second aligning angle wherein at least one second Component contained within the inner rotating cylinder interior compartment cannot escape the inner rotating cylinder interior compartment and at least one first Component and/or the New Mixture contained within the outer container cannot enter the rotatable applicator valve assembly and the rigid containment and release vessel being capable of being set to a mixing position at a third aligning angle wherein at least two outer release slots and at least two inner release slots are aligned and at least one second Component can pass out of the inner rotating cylinder interior compartment and mix with at least one first Component contained within the outer container when external pressure and/or massaging and/or squeezing and/or manual force is applied to the outer container to create the New Mixture and the ⁻New Mixture is contained within the outer container and cannot enter the rotatable applicator valve assembly and the rigid containment and release vessel being capable of being set to a valve open position at a first aligning angle wherein at least two outer release slots and at least two inner release slots are aligned and at least one second Component can pass out of the inner rotating cylinder interior compartment and mix with at least one first Component contained ⁻within the outer container to create and/or continue to create the New Mixture and the ⁻New Mixture contained within the outer container and can enter the rotatable applicator valve assembly when external pressure and/or massaging and/or squeezing and/or manual force is applied to the outer container and/or when pressure increases sufficiently within the interior of the outer container.

The filter can be at least one of in whole or in part foam, rubber, plastic, metal, screening, mesh, cotton, ceramic, fibrous material.

The applicator tip can be at least one of a brush, foam, sponge, a comb, a nozzle, a membrane permitting material transfer and/or diffusion, a tube or and/or series of tubes.

The outer container can have at least one mixing ball and/or solid object with the interior of the outer container.

The invention can have at least one additional hair care product contained in the outer container and/or in or on at least one portion of the invention.

Mixing can occur through the application of external pressure aid/or manual force and/or mixing can occur by the act of squeezing and/or shaking the outer container with at least one human hand.

The open top can contain integral screw threads capable of mating with complimentary screw threads on the rotatable applicator valve to enable the rotatable applicator valve to attach to the open top.

The valve open position and/or the rupture position can occur at a second aligning angle and/or mixing position at a third aligning angle can be designated and/or defined by at least one mechanical detent produced at the mating Surfaces of the rotatable first valve cylindrical plate and the stationary second valve cylindrical plate.

A method for the above described embodiment employing the first second Component dispensing system for applying a New Mixture to at least one Surface can comprise the following steps: A1) rotating a rotatable applicator valve assembly from at least one closed position to a rupture position at a second aligning angle to rupture a rupture membrane on a flexible vessel; B1) rotating the rotatable applicator valve assembly from the rupture position at a second aligning angle to a mixing position at a third aligning angle; C1) squeezing and/or massaging and/or shaking the outer container to mix the second Component contained within the flexible vessel with the first Component contained within the outer container to create the New Mixture; D1) rotating the rotatable applicator valve assembly from the mixing position at a third. aligning angle to a valve open position at a first aligning angle to allow the New Mixture to flow out of the outer container and/or the rotatable applicator valve assembly into the applicator tip contained within the rotatable applicator valve assembly; E1) squeezing the outer container to force the New Mixture out of the outer container into the applicator tip, and applying the New Mixture to at least one Surface and/or chosen hair area; F1) if there is any New Mixture remaining in the outer container, rotating the rotatable applicator valve assembly from the valve open position at a first aligning angle to any closed position to prevent the New Mixture from exiting and/or leaking out of the rotatable applicator valve assembly; or

employing the second, second Component dispensing system for applying a New Mixture to at least one Surface, a method can comprise the following steps A2) rotating a rotatable applicator valve assembly from at least one closed position to a mixing position at a second aligning angle; B2) squeezing and/or massaging and/or shaking the outer container to mix the second Component contained within a rigid vessel with the ⁻first Component contained within the outer container to create the New Mixture; D2) rotating the rotatable applicator valve assembly from the mixing position at a third aligning angle to a valve open position at a first aligning angle to allow the New Mixture to flow out of the outer container and/or the rotatable applicator valve assembly into the applicator tip contained within the rotatable applicator valve assembly; E2) squeezing the outer container to force the New Mixture out of the outer container into the applicator tip, and applying the New Mixture to at least one Surface and/or chosen hair area; F2) if there is any New Mixture remaining in the outer container, rotating the rotatable applicator valve assembly from the valve open position at a first aligning angle to any closed position to prevent the New Mixture from exiting and/or leaking out of the rotatable applicator valve assembly.

Although preferred embodiments of the present invention have been described herein it will be understood by those skilled in the art that the present invention should not be limited to the described preferred embodiments. Rather, various changes and modifications can be made within the spirit and scope of the present invention and the claims should not be limited thereby.

All of the material in this patent document and accompanying application papers are subject to copyright protection under the copyright laws of the United States and other countries. The copyright owner has no objection to the facsimile reproduction by anyone of the patent document, the patent disclosure and other papers as they appear in official governmental records but, otherwise, all other copyright rights whatsoever are reserved.

What is claimed is:

1. An integrated at least two component system for applying a substance to at least one surface comprising:
(A) an outer container made from a flexible material and having a closed bottom and sides and an open top, the outer container containing at least one first component;
(B) at least one breakable ampoule contained within the outer container; wherein the at least one breakable ampoule contains at least one second component, whereupon the rupturing and/or puncturing and/or breaking and/or crushing and/or squeezing of the at least one breakable ampoule, to release the at least one second component, allows mixing of the at least one first component with the at least one second component to form a new mixture;
the outer container further comprising at least one button for piercing and/or rupturing and/or puncturing and/or breaking and/or crushing and/or squeezing of the at least one breakable ampoule;
and
(C) a rotatable applicator valve assembly comprising:
a) an applicator subassembly for applying the new mixture comprising:
i) an applicator outer first end enabling the new mixture to pass from the interior of the rotatable applicator valve assembly through the applicator outer first end to the exterior ambient;
ii) an applicator inner second end containing a rotatable first valve cylindrical plate containing a rotatable first valve cylindrical plate hole;
b) a stationary second valve cylindrical plate attached to the open top while permitting rotation of the applicator subassembly,
the stationary second valve cylindrical plate containing a stationary second valve cylindrical plate hole,
the rotatable first valve cylindrical plate being capable of rotating when the applicator subassembly is rotated,
the rotatable first valve cylindrical plate hole capable of aligning at a first aligning angle with the stationary second valve cylindrical plate hole producing a valve open position and allowing the new mixture to pass from the interior of the outer container into the interior of the rotatable applicator valve assembly when the rotatable applicator valve assembly is rotated to an open position and/or when external pressure and/or manual force is applied to the outer container and/or when pressure increases sufficiently within the interior of the outer container,
and
when the rotatable first valve cylindrical plate hole is not aligned with the stationary second valve cylindrical plate hole the new mixture is blocked in at least one closed position and prevented from passing from the interior of the outer container into the interior of the rotatable applicator valve assembly.

2. The invention of claim 1, wherein the button has an inner end on one side of the button, located within the outer container, and an outer end on the other side, the inner end comprising at least one of the following:
A. a sharp end of a blade within the button for piercing and/or rupturing and/or puncturing and/or breaking the at least one breakable ampoule;
B. a blunt end for rupturing and/or puncturing and/or breaking and/or crushing and/or squeezing the at least one breakable ampoule;
C. an attaching device, attaching the inner end of the button to the at least one breakable ampoule, whereby the inner end of the button can pierce and/or rupture and/or puncture and/or break and/or crush and/or squeeze of the at least one breakable ampoule.

3. The invention of claim 1 wherein the outer first end has an applicator tip is at least one of a brush, foam, sponge, a comb, hose, a nozzle, a membrane permitting material transfer and/or diffusion, an applicator tip material, a tube or series of tubes.

4. The invention of claim 1, further comprising a filter contained within the outer container or the rotatable applicator and valve assembly, or a filter surrounding and/or encasing the at least one breakable ampoule, the filter capable of preventing particulate material from passing from the outer container into the rotatable applicator valve assembly, and wherein the filter is at least one of in whole or in part foam, rubber, plastic, metal, screening, mesh, ceramic, cotton, and/or fibrous material.

5. The invention of claim 1, further comprising at least one of the following:
A. at least one additional hair care product contained in the outer container, in at least one breakable ampoule and/or in at least one additional breakable ampoule; and/or
B. at least one mixing ball and/or solid object within the interior of the outer container.

6. The invention of claim 1, wherein the external pressure and/or manual force and/or the mixing is generated by the act of squeezing and/or shaking the outer container with at least one human hand.

7. The invention of claim 1, wherein the open top contains integral screw threads capable of mating with complimentary screw threads on the rotatable applicator valve assembly to enable the rotatable applicator valve to attach to the open top.

8. The invention of claim 1, wherein the valve open position and/or the at least one closed position are designated and/or defined by at least one mechanical detent produced at the mating surfaces of the rotatable first valve cylindrical plate and the stationary second valve cylindrical plate.

9. The invention of claim 1, wherein the ampoule further comprises of at least one of a breakable sealed glass container, a housing, at least one breakaway membrane, at least one puncturing and/or piercing edge and/or tooth to puncture the at least one breakaway membrane when the external pressure and/or manual force is applied to at least one location to the outer container.

10. A method for applying a new mixture to at least one surface comprising at least one of the following steps:
A)
1) pushing at least one button on an outer container to break at least one ampoule contained within the outer container, the outer container also containing at least one first component and the at least one ampoule containing at least one second component;
2) squeezing and massaging the outer container to mix the at least one second component contained within the ampoule with the at least one first component contained within the outer container to create the new mixture;
3) rotating a rotatable applicator valve assembly from at least one closed position to an open position to allow the new mixture to flow out of the rotatable applicator valve assembly into the applicator tip contained within the rotatable applicator valve assembly;
4) squeezing the outer container to force the new mixture out of the outer container into the applicator tip, and applying the new mixture to chosen surface or hair area;
5) if there is any new mixture remaining in the outer container, rotating the rotatable applicator valve assembly from the open position to the at least one closed position to prevent the new mixture from exiting and/or leaking out of the rotatable applicator valve assembly
or
B)
1) pushing at least one button on an outer container to pierce and/or rupture and/or puncture and/or break at least one ampoule contained within the outer container, whereby pushing the at least one button causes a blade within the button to push out from within the button into the outer container to pierce and/or rupture and/or puncture and/or break the at least one ampoule contained within the outer container, the outer container also containing at least one first component and the at least one ampoule containing at least one second component;
2) squeezing and massaging the outer container to mix the at least one second component contained within the ampoule with the at least one first component contained within the outer container to create the new mixture;
3) rotating a rotatable applicator valve assembly from at least one closed position to an open position to allow the new mixture to flow out of the rotatable applicator valve assembly into the applicator tip contained within the rotatable applicator valve assembly;
4) squeezing the outer container to force the new mixture out of the outer container into the applicator tip, and applying the new mixture to chosen surface or hair area;
5) if there is any new mixture remaining in the outer container, rotating the rotatable applicator valve assembly from the open position to the at least one closed position to prevent the new mixture from exiting and/or leaking out of the rotatable applicator valve assembly;
or
C)
1) pushing at least one button on an outer container to rupture and/or puncture and/or break and/or crush and/or squeeze at least one ampoule contained within the outer container, whereby pushing the at least one button causes an inner end of the button to push out into the outer container to rupture and/or puncture and/or break and/or crush and/or squeeze the at least one ampoule contained within the outer container,
the outer container also containing at least one first component and the at least one ampoule containing at least one second component;
2) squeezing and massaging the outer container to mix the at least one second component contained within the ampoule with the at least one first component contained within the outer container to create the new mixture;
3) rotating a rotatable applicator valve assembly from at least one closed position to an open position to allow the new mixture to flow out of the rotatable applicator valve assembly into the applicator tip contained within the rotatable applicator valve assembly;
4) squeezing the outer container to force the new mixture out of the outer container into the applicator tip, and applying the new mixture to chosen surface or hair area;
5) if there is any new mixture remaining in the outer container, rotating the rotatable applicator valve assembly from the open position to the at least one closed position to prevent the new mixture from exiting and/or leaking out of the rotatable applicator valve assembly;
or
D)
1) pushing at least one set of buttons on an outer container to rupture and/or puncture and/or break and/or crush and/or squeeze at least one ampoule contained within the outer container, each set of buttons having at least two buttons on opposing sides of the outer container whereby the set of buttons can be pressed against each other to rupture and/or puncture and/or break and/or crush and/or squeeze at least one ampoule contained within the outer container,
the outer container also containing at least one first component and the at least one ampoule containing at least one second component;
2) squeezing and massaging the outer container to mix the at least one second component contained within the ampoule with the at least one first component contained within the outer container to create the new mixture;
3) rotating a rotatable applicator valve assembly from at least one closed position to an open position to allow the new mixture to flow out of the rotatable applicator valve assembly into the applicator tip contained within the rotatable applicator valve assembly;
4) squeezing the outer container to force the new mixture out of the outer container into the applicator tip, and applying the new mixture to chosen surface or hair area;
5) if there is any new mixture remaining in the outer container, rotating the rotatable applicator valve assembly from the open position to the at least one closed position to prevent the new mixture from exiting and/or leaking out of the rotatable applicator valve assembly;
or
E)
1) rotating a rotatable applicator valve assembly from at least one closed position to a rupture position at a second aligning angle to rupture a rupture membrane on a vessel contained within an outer container, the outer container containing a first component and the vessel containing a second component;
2) rotating the rotatable applicator valve assembly from the rupture position at a second aligning angle to a mixing position at a third aligning angle;
3) squeezing and/or massaging and/or shaking the outer container to mix the second component contained within the flexible vessel with the first component contained within the outer container to create the new mixture;
4) rotating the rotatable applicator valve assembly from the mixing position at a third aligning angle to a valve open position at a first aligning angle to allow the new mixture to flow out of the outer container and/or the rotatable applicator valve assembly into the applicator tip contained within the rotatable applicator valve assembly;
5) squeezing the outer container to force the new mixture out of the outer container into the applicator tip, and applying the new mixture to at least one surface and/or chosen hair area;
6) if there is any new mixture remaining in the outer container, rotating the rotatable applicator valve assembly from the valve open position at a first aligning angle to any closed position to prevent the new mixture from exiting and/or leaking out of the rotatable applicator valve assembly.

11. An integrated at least two component system for applying a substance to at least one surface comprising:
a container made from a flexible material and having a closed bottom and sides, an interior and an open top for applying a substance, the container having at least one first section adjacent the open top and at least one second section adjacent the closed bottom, the at least one first section containing at least one first component, the at least one second section containing at least one second component;
at least one, one-way valve, interposed between the at least one first section and the at least one second section, the valve having a valve head containing an opening through which the second component can enter the first section to mix with the first component when the container is squeezed to create a mixture.

12. The invention of claim 11, further comprising a rotatable applicator valve assembly comprising:
a) an applicator subassembly for applying the mixture comprising:
i) an applicator nozzle outer first end containing an applicator tip enabling the new mixture to pass from the interior of the rotatable applicator valve assembly through the applicator tip to the exterior ambient;
ii) an applicator nozzle inner second end containing a rotatable first valve cylindrical plate containing a rotatable first valve cylindrical plate hole;
b) a stationary second valve cylindrical plate attached to the open top while permitting rotation of the applicator subassembly,
the stationary second valve cylindrical plate containing a second valve cylindrical plate hole,
the rotatable first valve cylindrical plate being capable of rotating when the applicator subassembly is rotated,
the rotatable first valve cylindrical plate hole capable of aligning at a first aligning angle with the stationary second valve cylindrical plate hole producing a valve open position to allow the mixture to pass from the interior of the container into the interior of the rotatable applicator valve assembly when the rotatable applicator valve assembly is rotated to an open position and/or when external pressure and/or manual force is applied to the container and/or when pressure increases sufficiently within the interior of the container,
and
when the rotatable first valve cylindrical plate hole is not aligned with the stationary second valve cylindrical plate hole the new mixture is blocked and prevented from passing from the interior of the outer container into the interior of the rotatable applicator valve assembly.

13. The invention of claim 12, further comprising a filter contained within the outer container or the rotatable applicator and valve assembly, or a filter surrounding and/or encasing the at least one vessel, the filter capable of preventing particulate material from passing from the outer container into the rotatable applicator valve assembly, and wherein the filter is at least one of in whole or in part foam, rubber, plastic, metal, screening, mesh, cotton, ceramic, fibrous material.

14. The invention of claim 12, wherein the applicator tip is at least one of a brush, foam, sponge, a comb, a nozzle, an applicator tip material, a membrane permitting material transfer and/or diffusion, a tube or and/or series of tubes.

15. The invention of claim 12, further comprising at least one of the following:
A. at least one mixing ball and/or solid object in the container; and/or
B. at least one additional hair care product contained in the container and/or in at least one portion of the invention of claim 12.

16. The invention of claim 12, wherein the external pressure and/or manual force and/or the mixing is generated by the act of squeezing and/or shaking the outer container with at least one human hand.

17. The invention of claim 12, wherein the open top contains integral screw threads capable of mating with complimentary screw threads on the rotatable applicator valve to enable the rotatable applicator valve to attach to the open top.

18. The invention of claim 12, wherein the valve open position and/or the rupture position at a second aligning angle and/or the mixing position at a third aligning angle are designated and/or defined by at least one mechanical detent produced at the mating surfaces of the rotatable first valve cylindrical plate and the stationary second valve cylindrical plate.

19. The invention of claim 12, further comprising a method of squeezing the second section to open the valve and mix the first and second components to create a new mixture.

20. The invention of claim 19, further comprising:
rotating a rotatable applicator valve assembly from at least one closed position to an open position to allow the new mixture to flow out of the rotatable applicator valve assembly into an applicator tip contained within the rotatable applicator valve assembly;
squeezing the container to force the new mixture out of the container into the applicator tip, and applying the new mixture to chosen surface or hair area;
if there is any new mixture remaining in the container, rotating the rotatable applicator valve assembly from the open position to the at least one closed position to prevent the new mixture from exiting and/or leaking out of the rotatable applicator valve assembly.
